(19) United States
(12) Patent Application Publication
(10) Pub. No.: US 2026/0106449 A1
(43) Pub. Date: Apr. 16, 2026

(54) Minimum voltage or loss voltage shunt trip device for a circuit breaker, associated assembly and process

(71) Applicant: Schneider Electric Industries SAS, Rueil Malmaison (FR)

(72) Inventors: Hugo MABILLOT, Grenoble (FR); Alexandre MORIN, Seyssins (FR)

(21) Appl. No.: 19/340,246

(22) Filed: Sep. 25, 2025

(30) Foreign Application Priority Data
Oct. 4, 2024 (FR) FR2410742

(51) Int. Cl. H02H 3/20; H02H 1/00

(52) U.S. Cl. CPC H02H 3/20; H02H 1/0007

(57) ABSTRACT

The present invention relates to a minimum voltage or loss voltage shunt trip device (1) for a circuit breaker (2). The trip device (1) comprises:
a loading block (7), electrically connected between a first terminal (3) and a second terminal (5), comprising a load (16) set up to activate the circuit breaker (2);
a protection module (9), comprising:
   a thyristor for protection against over-voltages (27) and a varistor (29), in series with each other and in parallel with the loading block (7); and
   a first capacitor (33), in parallel with the varistor (29);
a fusible element (15) and a first resistive wire (11) in series with each other, connected between the first terminal (3) and the protection module (9); and
a second resistive wire (13), connected between the protection module (9) and the second terminal (5).

### TECHNICAL FIELD

The present invention relates to a minimum voltage or loss voltage shunt trip device. It also relates to an assembly comprising such a trip device and a circuit breaker. Lastly, it relates to a process for tripping such a circuit breaker.

### BACKGROUND

A circuit breaker is a protection device for an electrical installation able to be actuated remotely by a minimum voltage or loss voltage shunt trip device (also referred to as ‘shunt trip actuator’ or ‘close trip actuator’) according to the standard IEC 60947-2, when this trip device detects the presence of a voltage exceeding a threshold. Such devices may notably be installed at the head of an electrical installation, where the electrical power is relatively high.

When they are inserted into an electrical distribution network, the minimum voltage or loss voltage shunt trip devices are subjected to occasional variations in voltages of variable amplitude. These voltage variations are capable of causing the breakage of the trip devices and a loss of service over the whole of the electrical installation.

Various techniques are known allowing an actuator to be protected against over-voltages in an electronic device. For example, a known technique is to use a thyristor and a varistor in series in order to attenuate the over-voltages. Notably, the document WO202325609A1 describes a process of operation of a device comprising a protection against over-voltages by means of a thyristor and of a varistor in parallel with a capacitor and a resistor.

However, the existing solutions for protection against over-voltages are not adapted to and optimized for minimum voltage or loss voltage shunt trip devices, which have particular constraints on size and structure.

### SUMMARY

The aim of the invention is accordingly to provide a minimum voltage or loss voltage shunt trip device having an enhanced resistance to over-voltages coming from an electrical distribution network external to the device, while taking into account constraints on size, on cost and on structure of such equipment.

For this purpose, the subject of the invention is a minimum voltage or loss voltage shunt trip device for a circuit breaker, the trip device comprising:
a first terminal and a second terminal for applying an input voltage between them;
a loading block, electrically connected between the first terminal and the second terminal, comprising a load set up to actuate an opening or a closing of the circuit breaker by means of a mechanical actuator;
a protection module, comprising:
   a thyristor for protection against over-voltages, electrically connected between a first intermediate point and a second intermediate point; and
   a varistor, electrically connected between the second intermediate point and a third intermediate point, in series with the thyristor for protection against over-voltages, the thyristor for protection against over-voltages and the varistor being in parallel with the loading block;
a first capacitor, belonging to the protection module, electrically connected in parallel with the varistor;
a fusible element and a first resistive wire in series with each other, electrically connected between the first terminal and the protection module, the first resistive wire having a resistance higher than or equal to 0.5Ω; and
a second resistive wire, having a resistance higher than or equal to 0.5Ω, electrically connected between the protection module and the second terminal.

By virtue of the invention, an over-voltage coming from the external electrical distribution network, occurring between the first terminal and the second terminal, is partially attenuated by the thyristor and the varistor in series, in such a manner as to protect the load. Notably, the presence of the thyristor allows the size of the varistor to be reduced, and hence the space occupied in the device to be limited, for the same capacity to attenuate over-voltages. Furthermore, the first capacitor and the resistive wires allow a residual over-voltage between the terminals of the varistor to be absorbed. The reason for this is that the thyristor becomes conducting before the varistor, which results in an over-voltage of very short duration between the terminals of the varistor, which could eventually alter the lifetime of the varistor. The attenuation of the over-voltage by the first capacitor and the resistive wires allows this effect to be limited, thus prolonging the lifetime of the trip device. Furthermore, the presence of the resistive wires which allow the current to be limited when an over-voltage occurs and of the fusible element which allows the risk of over-heating and/or of the trip device catching fire to be reduced in the case of failure of the thyristor or of the varistor.

According to other advantageous aspects of the invention, the trip device comprises one or more of the following features, taken in isolation or according to all the technically possible combinations:
the trip device comprises a first resistance in series with the first capacitor, the resistance and the first capacitor being in parallel with the varistor;
the loading block comprises a voltage rectifier bridge, the voltage rectifier bridge taking as input a voltage between the terminals of the protection module and producing at the output a voltage between the terminals of the load;
the trip device comprises a detection module, electrically connected at least to the second intermediate point and to a monitoring unit and set up to detect and to transmit to the monitoring unit an occurrence of an over-voltage event between the first terminal and the second terminal;
the detection module comprises:
   a first diode, electrically connected between the second intermediate point and a fourth intermediate point;
   a second resistor, electrically connected between the fourth intermediate point and a fifth intermediate point;
   a third resistor, electrically connected between the fifth intermediate point and a ground;
   a second diode, electrically connected between the third intermediate point and the fourth intermediate point;
   a third diode, electrically connected between the fifth intermediate point and a sixth intermediate point;
   a second capacitor, electrically connected between the sixth intermediate point and the ground; and
   a fourth resistor, electrically connected between the sixth intermediate point and the monitoring unit;
      and the fifth intermediate point is electrically connected with the monitoring unit;
the loading block comprises a third filtering capacitor electrically connected in parallel with the load;
the load comprises:
   a measurement module, set up to measure the voltage between the terminals of the load;
   an engagement coil, set up to activate the mechanical actuator; and
   a holding coil, set up to keep the mechanical actuator in position;
the trip device is a minimum voltage shunt trip device and the mechanical actuator is set up to:
   open the circuit breaker after activation by the engagement coil; or
   close the circuit breaker after activation by the engagement coil;
the trip device is a loss voltage shunt trip device and the mechanical actuator is set up to:
   open the circuit breaker after activation by the engagement coil; and
   prevent the closing of the circuit breaker when the mechanical actuator is held in position by the holding coil.

The invention also relates to an assembly comprising a trip device according to the preceding description and a circuit breaker.

Such an assembly offers the same advantages as the trip device of the invention, in particular an increased lifetime of the trip device.

The invention also relates to a process of operation of the trip device belonging to an assembly according to the preceding description, in the case of an over-voltage between the first terminal and the second terminal, generating an over-voltage current between the first terminal and the second terminal, the process comprising:
flowing the over-voltage current through the fusible element, the first resistive wire and the second resistive wire;
a primary diversion of at least a part of the over-voltage current through the thyristor for protection against over-voltages and the varistor;
a secondary diversion of at least another part of the over-voltage current through the first capacitor; and
activation of the mechanical actuator by the load.

This process has the advantage that the function of opening or of closing of the circuit breaker by the trip device is provided at the same time as the electrical energy due to the over-voltage is dissipated during the primary and secondary diversions, thus preserving the various components of the trip device against the over-voltages.

### BRIEF DESCRIPTION OF DRAWINGS

The invention will become more clearly apparent upon reading the description that follows, given solely by way of non-limiting example, and presented with reference to the drawing wherein:

FIG. 1 is a diagram of an assembly comprising a circuit breaker and a minimum voltage or loss voltage shunt trip device according to the invention.

### DETAILED DESCRIPTION

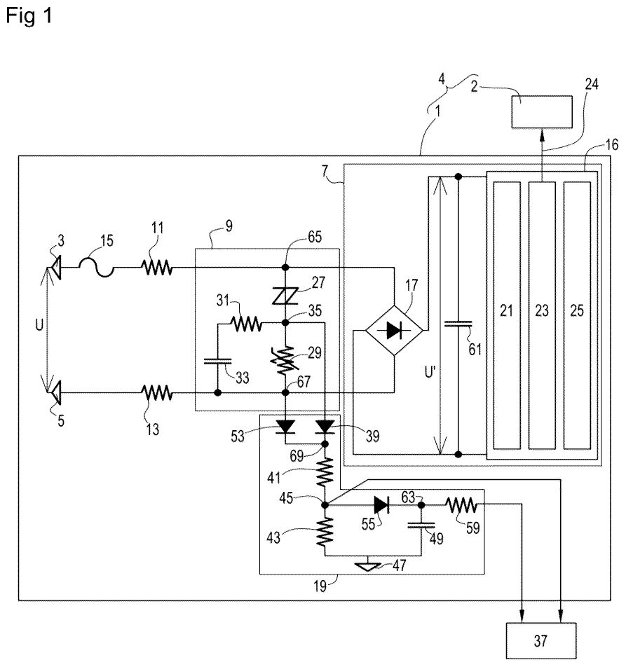

FIG. 1 illustrates a minimum voltage or loss voltage shunt trip device 1 for a circuit breaker 2. The trip device 1 and the associated circuit breaker 2 form an assembly 4, designed to be inserted into an electrical installation not shown. In particular, the assembly 4 is advantageously designed to be inserted at the head of an electrical installation and connected to an external electrical distribution network.

As a variant not shown, the trip device 1 is integrated into the circuit breaker 2.

The trip device 1 comprises a first terminal 3 and a second terminal 5, a loading block 7, a protection module 9, a first resistive wire 11, a second resistive wire 13 and an optional fusible element 15. Advantageously, the trip device 1 furthermore comprises a detection module 19.

The trip device 1 is connected to the external electrical distribution network by the first terminal 3 and the second terminal 5. The external electrical distribution network applies an input voltage U between the first terminal 3 and the second terminal 5. Thus, the terminals 3 and 5 are terminals for application of the voltage U at the input of the trip device 1. Advantageously, the objective of the trip device 1 is to remotely actuate the circuit breaker 2, in such a manner as to interrupt or to re-establish a flow of a current in the electrical installation depending on the input voltage U.

According to a first example of the invention, the trip device 1 is a minimum voltage shunt trip device. In other words, the circuit breaker 1 is set up to actuate the circuit breaker 2 when the input voltage U exceeds a certain predetermined maximum voltage threshold. An over-voltage, or over-voltage event, refers to the input voltage U going above the predetermined maximum voltage threshold.

According to a second example of the invention, the trip device 1 is a loss voltage shunt trip device. In other words, the trip device 1 is set up to actuate the circuit breaker 2 when the input voltage U goes below a predetermined minimum voltage threshold.

In the following part of the description, the case of the minimum voltage shunt trip device is described, where the case of the loss voltage shunt circuit breaker may be deduced by analogy.

The loading block 7 is electrically connected between the first terminal 3 and the second terminal 5 and comprises a load 16, set up to actuate an opening or a closing of the circuit breaker 2. Advantageously, the loading block 7 furthermore comprises a voltage rectifier bridge 17.

The load 16 advantageously comprises a measurement module 21, an engagement coil 23 and a holding coil 25.

The role of the measurement module 21 is to measure the voltage U′ between the terminals of the load 16 and to compare this voltage U′ with the predetermined maximum voltage threshold.

The engagement coil 23 is set up to activate a mechanical actuator 24. The mechanical actuator 24 is advantageously set up to open the circuit breaker 2 after activation by the engagement coil 23, thus interrupting a current flowing in the electrical installation. As a variant, the mechanical actuator 24 is set up to close the circuit breaker 2 after activation by the engagement coil 23. The mechanical actuator 24 is for example a mechanical finger which, by translation between an extended position and a retracted position, acts on a mechanism of the circuit breaker 2 in such a manner as to open or to close the circuit breaker 2.

The holding coil 25 is set up to hold the mechanical actuator 24 in the extended or retracted position. Advantageously, the mechanical actuator 24 is set up to release the circuit breaker 2 when the mechanical actuator 24 is no longer held by the holding coil 25, so as to allow the circuit breaker 2 to return to its initial open or closed state.

In the case of a loss voltage shunt trip device, the mechanical actuator 24 is set up to open the circuit breaker 2 after activation by the engagement coil 23 and to prevent the closing of the circuit breaker 2 when the mechanical actuator 24 is held in position by the holding coil 25.

The voltage rectifier bridge 17 takes as input the voltage U between the terminals of the protection module 9 and produces at the output a voltage U′ between the terminals of the load 16. The voltage rectifier bridge 17 is advantageous when the electrical distribution network supplies an AC input voltage U. The voltage rectifier bridge 17 then allows the AC input voltage U to be converted into a DC voltage U′ between the terminals of the load 16.

The role of the protection module 9 is to protect the trip device 1 against the over-voltages occurring in the external electrical distribution network, in other words the over-voltages of the input voltage U. The protection module comprises a thyristor for protection against over-voltages 27, a varistor 29 and a first capacitor 33.

The varistor 29 is electrically connected between a second intermediate point 35 and a third intermediate point 67. The varistor 29 exhibits a resistance which varies as a function of the voltage across its terminals. When the voltage between the terminals of the varistor 29 is low, hence in the absence of an over-voltage, the varistor 29 has a first, relatively high, value of resistance and therefore has a relatively low current flowing through it. When the voltage between the terminals of the varistor 29 exceeds a certain threshold, the resistance of the varistor 29 falls dramatically to reach a second value of resistance, allowing a relatively high current to flow through the varistor 29, dissipating a part of the electrical energy of the over-voltage. The varistor 29 is then considered to be conducting.

By way of non-limiting example, the first value of resistance is higher than 10 megaohms for an input voltage U, for example of the order of 200 to 250V, whereas the second value of resistance is lower than 0.5 ohms in the presence of an over-voltage.

The thyristor for protection against over-voltages 27 is electrically connected between a first intermediate point 65 and the second intermediate point 35, in series with the varistor 29. The presence of the thyristor for protection against over-voltages 27 allows the size of varistor 29 needed to handle over-voltages from the external electrical distribution network to be limited, a leakage current flowing in the varistor 29 in the absence of an over-voltage to be limited, the risk of a short-circuit occurring in the case of failure of the varistor 29 to be reduced, and also a diversion of the current in the case of a high over-voltage to be made more reliable.

Advantageously, the thyristor for protection against over-voltages 27 is an assembly composed of two thyristors and of protection diodes.

The first capacitor 33 is electrically connected in parallel with the varistor 29. In combination with the resistive wires 11 and 13, the first capacitor 33 protects the varistor 29 in the case of a high over-voltage by also dissipating a part of the electrical energy of the over-voltage. The presence of the resistive wires 11 and 13 and of the first capacitor 33 therefore allows the lifetime of the trip device 1, and notably of the varistor 29, to be increased in the context of an unstable external electrical distribution network.

In the example shown in FIG. 1, the protection module 9 furthermore comprises a first resistor 31 in series with the first capacitor 33, the first resistor 31 and the first capacitor 33 being in parallel with the varistor 29. The first resistor 31 and the first capacitor 33 thus form an RC loop in parallel with the varistor 29, providing an enhanced protection to the varistor 29 in the case of a high over-voltage.

However, the first resistor 31 is optional since, as explained above, its role may be assumed by the resistive wires 11 and 13, allowing space to be saved in the trip device 1.

By way of non-limiting example, the first resistor 31 has a value of resistance in the range between 0 and 63 ohms (the 0 Ohms case corresponding to the absence of a first resistor 31), whereas the first capacitor 33 has a value of capacitance in the range between 10 picofarads and 100 nanofarads, for an input voltage U for example of the order of 200 to 250V.

Furthermore, the protection module 9 exhibits an overall capacitance improving electromagnetic compatibility of the trip device 1, in other words providing the trip device 1 with a low sensitivity to electromagnetic interference.

The first resistive wire 11 is connected in series with the fusible element 15. The assembly composed of the first resistive wire 11 and of the fusible element 15 in series is electrically connected between the first terminal 3 and the protection module 9. In the example shown in FIG. 1, the fusible element 15 is electrically connected to the first terminal 3 and the first resistive wire 11 is electrically connected to the protection module 9. As a variant not shown, the fusible element 15 is electrically connected to the protection module 9 and the first resistive wire 11 is electrically connected to the first terminal 3.

The first resistive wire 11 is a conducting wire having a resistance higher than or equal to 0.5Ω, preferably equal to 1.5Ω for an input voltage U, for example of the order of 200 to 250V. The choice of a resistive wire 11 allows a space saving and a simplification with respect to a conducting wire connected to a separate resistive element.

Similarly, the second resistive wire 13 connects the second terminal 5 to the protection module 9 and is a conducting wire having a resistance higher than or equal to 0.5Ω, preferably equal to 1.5Ω for an input voltage U, for example, of the order of 200 to 250V.

Advantageously, the first and second resistive wires 11 and 13 have substantially equal resistances. This symmetry allows the electromagnetic compatibility of the trip device 1 to be improved.

As a variant, the resistive wires 11 and 13 are conducting wires connected to a respective resistive element, as shown in FIGS. 1 and 2.

The resistive wires 11 and 13 allow a dissipation of a part of the over-voltage electrical energy without requiring much space.

The fusible element 15 is set up to fuse when a current higher than a predetermined critical current flows through it, which allows all of the components of the trip device 1 to be protected in the case of an electrical failure, thus prolonging their lifetime. Furthermore, the presence of the resistive wires 11 and 13 and of the fusible element 15 allows the electrical energy to be dissipated in the case of a failure of the thyristor for protection against over-voltages 27 and/or of the varistor 29, thus reducing a risk of overheating and/or of the trip device 1 catching fire.

The detection module 19 is optional.

The detection module 19 takes advantage of the architecture previously described by detecting the over-voltages for the purposes of monitoring the over-voltage events and of predictive maintenance of the components of the trip device 1, and notably of the varistor 29. Indeed, knowing the number of occurrences of over-voltage events, by means of the detection module 19, and the number of switching operations during the lifetime of the varistor 29, by means of tables supplied by the manufacturer of the varistor, it is possible to predict the remaining lifetime of the varistor 29. Furthermore, the detection module 19 allows a short-circuit to be detected at the second intermediate point 35, revealing a failure of the varistor 29 and of the thyristor for protection against over-voltages 27.

The detection module 19 is electrically connected at least to the second intermediate point 35 and to a monitoring unit 37 internal to the trip device 1 and to the circuit breaker 2.

As a variant not shown, the monitoring unit 37 is integrated into the circuit breaker 2.

The detection module 19 comprises a first diode 39, a second resistor 41, a third resistor 43, a second diode 53, a third diode 55, a second capacitor 49 and a fourth resistor 59.

The first diode 39 is electrically connected between the second intermediate point 35 and a fourth intermediate point 69. The second resistor 41 is electrically connected in series with the first diode 39, between the fourth intermediate point 69 and a fifth intermediate point 45. The third resistor 43 is electrically connected in series with the second resistor 41, between the fifth intermediate point 45 and a ground 47. The fifth intermediate point 45 is electrically connected to the monitoring unit 37. Depending on a value of voltage between the fifth intermediate point 45 and the ground 47 of the trip device 1, the monitoring unit 37 is able to detect an occurrence of an over-voltage event.

By way of non-limiting example, the second resistor 41 and the third resistor 43 each have a value of resistance in the range between 10 ohms and several megaohms, for an input voltage U, for example of the order of 200 to 250V.

By way of non-limiting example, the second capacitor 49 has a capacitance value in the range between 10 picofarads and 100 microfarads, whereas the fourth resistor 59 has a resistance value in the range between 10 ohms and several megohms, for an input voltage U for example of the order of 200 to 250V.

The second diode 53 is electrically connected between the third intermediate point 67 and the fourth intermediate point 69. The third diode 55 is electrically connected between the fifth intermediate point 45 and a sixth intermediate point 63. The second capacitor 49 is electrically connected between the sixth intermediate point 63 and the ground 47. The fourth resistor 59 is electrically connected between the sixth intermediate point 63 and the monitoring unit 37. This second connection of the detection module 19 to the monitoring unit 37 allows the monitoring unit 37 to detect, in addition to the occurrence of the over-voltage event, the level of this over-voltage.

Advantageously, the loading block 7 furthermore comprises a third capacitor 61, electrically connected in parallel with the load 16. The third capacitor 61 allows the voltage U′ between the terminals of the load 16 to be filtered in order to improve the measurement of this voltage by the measurement module 21.

A process for tripping a circuit breaker 2 by means of a trip device 1 according to the preceding description is described in the following part of the description.

The tripping process is executed automatically, owing to the electronic architecture of the trip device 1 previously described, in the case of an over-voltage occurring between the first terminal 3 and the second terminal 5.

The over-voltage generates an over-voltage current between the first terminal 3 and the second terminal 5. The over-voltage current is obliged to flow through the fusible element 15, the first resistive wire 11 and the second resistive wire 13. As soon as the over-voltage appears, the process comprises a primary diversion of at least a part of the over-voltage current through the thyristor for protection against over-voltages 27 and the varistor 29 of the protection module 9. In other words, the current does not totally flow through the loading block 7. This allows the load 16 to be protected against the over-voltage.

At the same time as the primary diversion, the process comprises a secondary diversion of at least another part of the over-voltage current through the first capacitor 33. In other words, the part of the over-voltage current flowing through the protection module 9 is divided between the varistor 29, on the one hand, and the first capacitor 33 on the other. This secondary diversion, in combination with the flow of the over-voltage current through the resistive wires 11 and 13, allows the varistor 29 to be protected from a premature degradation due to repeated high over-voltages. In particular, since the varistor 29 generally becomes conducting a few nanoseconds after the thyristor for protection against over-voltages 27, the secondary diversion protects the varistor 29 during this interval.

Furthermore, if the over-voltage current remains too high despite the aforementioned diversions, the fusible element 15 fuses in order to preserve the trip device 1 from too great a temperature rise or even from catching fire.

At the same time as the primary and secondary diversions, the process comprises an activation of the mechanical actuator 24 by the load 16, advantageously leading to an opening or a closing of the circuit breaker 2. More precisely, the over-voltage of the input voltage U has an effect on the voltage U′ between the terminals of the load 16, which is measured by the measurement module 21. The measurement module 21 carries out a comparison of the measured voltage with the predetermined maximum voltage threshold.

The process advantageously comprises a detection of the over-voltage event by virtue of the detection module 19. More precisely, the over-voltage of the input voltage U has an effect at the second intermediate point 35, then at the fifth intermediate point 45, which is connected to the monitoring unit 37. By virtue of this input, the monitoring unit 37 is able to count an occurrence of an over-voltage event. The detection of the over-voltage event allows a monitoring of over-voltage events by the monitoring unit 37, together with, as previously explained, a predictive maintenance of the components of the trip device 1.

Any feature described hereinabove for one embodiment or one variant may also be implemented in the other embodiments and variants described hereinabove, as long as this is technically possible.

1. Minimum voltage or loss voltage shunt trip device for a circuit breaker, the trip device comprising:
a first terminal and a second terminal for application of an input voltage (U) between them;
a loading block, electrically connected between the first terminal and the second terminal, comprising a load set up to actuate an opening or a closing of the circuit breaker by means of a mechanical actuator; and
a protection module, comprising:
a thyristor for protection against over-voltages, electrically connected between a first intermediate point and a second intermediate point; and
a varistor, electrically connected between the second intermediate point and a third intermediate point, in series with the thyristor for protection against over-voltages, the thyristor for protection against over-voltages and the varistor being in parallel with the loading block;
a first capacitor, belonging to the protection module, electrically connected in parallel with the varistor;
a fusible element and a first resistive wire in series with each other, electrically connected between the first terminal and the protection module, the first resistive wire having a resistance higher than or equal to 0.5Ω; and
a second resistive wire, having a resistance higher than or equal to 0.5Ω, electrically connected between the protection module and the second terminal.

2. The trip device according to claim 1, comprising a first resistor in series with the first capacitor, the first resistor and the first capacitor being in parallel with the varistor.

3. The trip device according claim 1, wherein the loading block comprises a voltage rectifier bridge, the voltage rectifier bridge taking as input a voltage (U) between the terminals of the protection module and producing at an output a voltage (U′) between the terminals of the load.

4. The trip device according to claim 1, comprising a detection module, electrically connected at least to the second intermediate point and to a monitoring unit and set up to detect and to transmit to the monitoring unit an occurrence of an over-voltage event between the first terminal and the second terminal.

5. The trip device according to claim 4, wherein the detection module comprises:
a first diode, electrically connected between the second intermediate point and a fourth intermediate point;
a second resistor, electrically connected between the fourth intermediate point and a fifth intermediate point;
a third resistor, electrically connected between the fifth intermediate point and a ground;
a second diode, electrically connected between the third intermediate point and the fourth intermediate point;
a third diode, electrically connected between the fifth intermediate point and a sixth intermediate point;
a second capacitor, electrically connected between the sixth intermediate point and the ground; and
a fourth resistor, electrically connected between the sixth intermediate point and the monitoring unit;
and wherein the fifth intermediate point is electrically connected with the monitoring unit.

6. The trip device according to claim 1, wherein the loading block comprises a third filtering capacitor electrically connected in parallel with the load.

7. The trip device according to claim 1, wherein the load comprises:
a measurement module, set up to measure the voltage (U′) between the terminals of the load;
an engagement coil, set up to activate the mechanical actuator; and
a holding coil, set up to hold the mechanical actuator in position.

8. The trip device according to claim 7, wherein the trip device is a minimum voltage shunt trip device and the mechanical actuator is set up to:
open the circuit breaker after activation by the engagement coil; or
close the circuit breaker after activation by the engagement coil.

9. The trip device according to claim 7, wherein the trip device is a loss voltage shunt trip device and the mechanical actuator is set up to:
open the circuit breaker after activation by the engagement coil; and
prevent the closing of the circuit breaker when the mechanical actuator is held in position by the holding coil.

10. (canceled)

11. A process of operation of the trip device belonging to an assembly comprising a circuit breaker and the trip device according to claim 1, in case of an over-voltage between the first terminal and the second terminal, generating an over-voltage current between the first terminal and the second terminal, the process comprising:
a flow of the over-voltage current through the fusible element, the first resistive wire and the second resistive wire;
a primary diversion of at least a part of the over-voltage current through the thyristor for protection against over-voltages and the varistor;
a secondary diversion of at least another part of the over-voltage current through the first capacitor; and
activation of the mechanical actuator by the load.

12. An assembly, comprising:
a circuit breaker; and
a minimum voltage or loss voltage shunt trip device, the trip device comprising:
a first terminal and a second terminal for application of an input voltage (U) between them;
a loading block, electrically connected between the first terminal and the second terminal, comprising a load set up to actuate an opening or a closing of the circuit breaker by means of a mechanical actuator;
a protection module, comprising:
a thyristor for protection against over-voltages, electrically connected between a first intermediate point and a second intermediate point;
a varistor, electrically connected between the second intermediate point and a third intermediate point, in series with the thyristor for protection against over-voltages, the thyristor for protection against over-voltages and the varistor being in parallel with the loading block;
a first capacitor, electrically connected in parallel with the varistor; and
a fusible element and a first resistive wire in series with each other, electrically connected between the first terminal and the protection module, the first resistive wire having a resistance higher than or equal to 0.5Ω; and
a second resistive wire, having a resistance higher than or equal to 0.5Ω, electrically connected between the protection module and the second terminal.

13. The assembly according to claim 12, wherein the trip device further comprises a first resistor in series with the first capacitor, the first resistor and the first capacitor being in parallel with the varistor.

14. The assembly according to claim 12, wherein the loading block comprises a voltage rectifier bridge, the voltage rectifier bridge taking as input a voltage (U) between the terminals of the protection module and producing at an output a voltage (U′) between the terminals of the load.

15. The assembly according to claim 12, wherein the trip device further comprises a detection module, electrically connected at least to the second intermediate point and to a monitoring unit and set up to detect and to transmit to the monitoring unit an occurrence of an over-voltage event between the first terminal and the second terminal.

16. The assembly according to claim 15, wherein the detection module comprises:
a first diode, electrically connected between the second intermediate point and a fourth intermediate point;
a second resistor, electrically connected between the fourth intermediate point and a fifth intermediate point;
a third resistor, electrically connected between the fifth intermediate point and a ground;
a second diode, electrically connected between the third intermediate point and the fourth intermediate point;
a third diode, electrically connected between the fifth intermediate point and a sixth intermediate point;
a second capacitor, electrically connected between the sixth intermediate point and the ground; and
a fourth resistor, electrically connected between the sixth intermediate point and the monitoring unit;
and wherein the fifth intermediate point is electrically connected with the monitoring unit.

17. The assembly according to claim 12, wherein the loading block comprises a third filtering capacitor electrically connected in parallel with the load.

18. The assembly according to claim 12, wherein the load comprises:
a measurement module, set up to measure the voltage (U′) between the terminals of the load;
an engagement coil, set up to activate the mechanical actuator; and
a holding coil, set up to hold the mechanical actuator in position.

19. The assembly according to claim 18, wherein the trip device is a minimum voltage shunt trip device and the mechanical actuator is set up to:
open the circuit breaker after activation by the engagement coil; or
close the circuit breaker after activation by the engagement coil.

20. The assembly according to claim 18, wherein the trip device is a loss voltage shunt trip device and the mechanical actuator is set up to:
open the circuit breaker after activation by the engagement coil; and
prevent the closing of the circuit breaker when the mechanical actuator is held in position by the holding coil.
